(19) United States
(12) Patent Application Publication
(10) Pub. No.: US 2008/0173837 A1
(43) Pub. Date: Jul. 24, 2008

(54) Electric automatic discharge valve

(75) Inventor: Pi-Fu Kung, Taipei City (TW)

Correspondence Address: Troxell Law Office Pllc, Suite 1404, 5205 Leesburg Pike, Falls Church, VA, 22041, US

(73) Assignee: AAA Enterprise Co., Ltd.

(21) Appl. No.: 11/657,129

(22) Filed: Jan. 24, 2007

(51) Int. Cl. F16K 31/02

(52) U.S. Cl. 251/129.2

(57) ABSTRACT

An electric automatic discharge valve is composed of a solenoid valve, a cylindrical tube, a fixing piece, a guiding gate, and a latching piece, wherein level difference of an inlet hole of the guiding gate is higher than a flow hole, and an interior of the guiding gate is provided with a slope, such that liquid can flow quickly, and impurities of the liquid can be removed effectively. In addition, by connecting the solenoid valve with an automatic control device, time of depressurization of the discharge valve can be controlled automatically, thereby achieving the functions of automatically depressurizing, and of discharging effectively.

### BACKGROUND OF THE INVENTION

a) Field of the Invention

The present invention relates to an electric automatic discharge valve, and more particularly to a discharge valve, wherein a guiding gate is improved that level difference of an inlet hole of the guiding gate is higher than a flow hole, such that liquid can flow out quickly and a vortex can be created.

b) Description of the Prior Art

Referring to FIG. 1 and FIG. 2, in a conventional discharge valve A, an outlet tube A2 and an inlet tube A3 of a guiding gate A1 are connected horizontally, such that when a guiding rod A4 is lifted upward at the guiding gate A1, liquid in the guiding gate A1 can pass through a guiding hole A5 successfully and be ejected out from a nozzle A6 of the outlet tube A2. However, for this horizontal connection method, when the liquid is flowing, as flow speed of the liquid is slow, it cannot be discharged completely, such that low discharge efficiency is achieved, and impurities of the liquid are easily retained in the outlet tube A2, guiding gate A1, and inlet tube A3.

Therefore, how to eliminate the aforementioned problems is a technical issue to be solved by the present inventor.

### SUMMARY OF THE INVENTION

The primary object of present invention is to provide an electric automatic discharge valve, wherein a guiding gate is improved that level difference of an inlet hole of the guiding gate is higher than a flow hole, such that liquid can flow out quickly and a vortex can be created. In addition, as there is a slope in the guiding gate, the liquid can be accelerated when being discharged, and impurities in the liquid can be removed effectively.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a prior art.

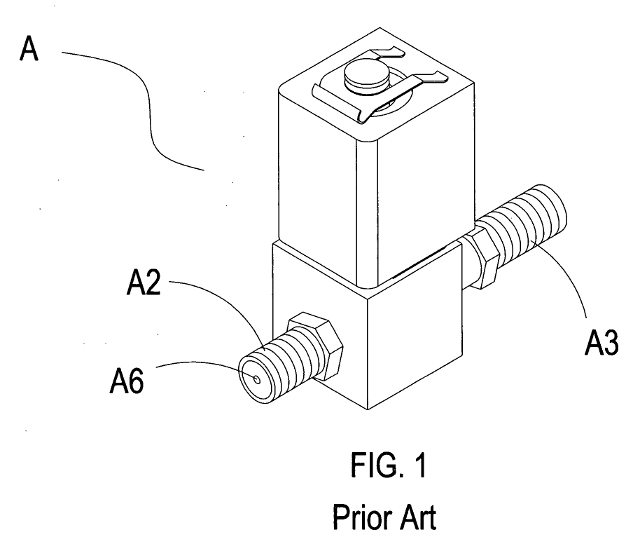

FIG. 2 shows a cutaway view of a prior art.

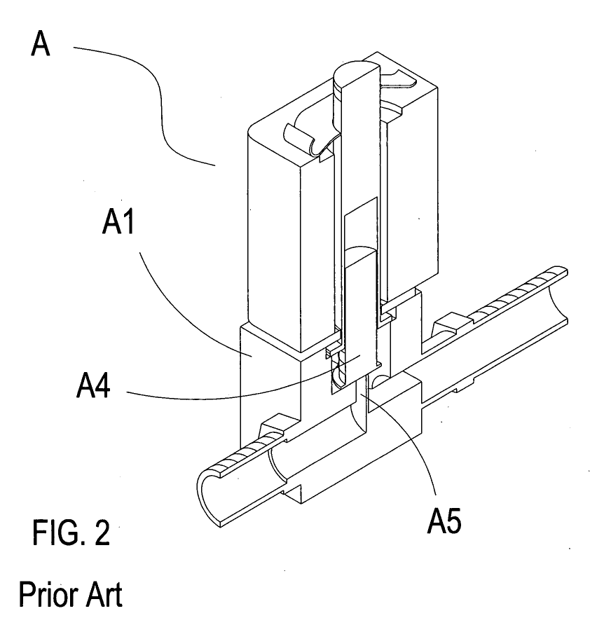

FIG. 3 shows a perspective view of the present invention.

FIG. 4 shows an exploded view of the present invention.

FIG. 5 shows a cutaway view of the present invention.

FIG. 6 shows a schematic view of an embodiment of the present invention.

FIG. 7 shows a second schematic view of an embodiment of the present invention.

FIG. 8 shows a schematic view of a further embodiment of the present invention.

FIG. 9 shows a second schematic view of a further embodiment of the present invention.

### DETAILED DESCRIPTION OF THE PREFERRED EMBODIMENTS

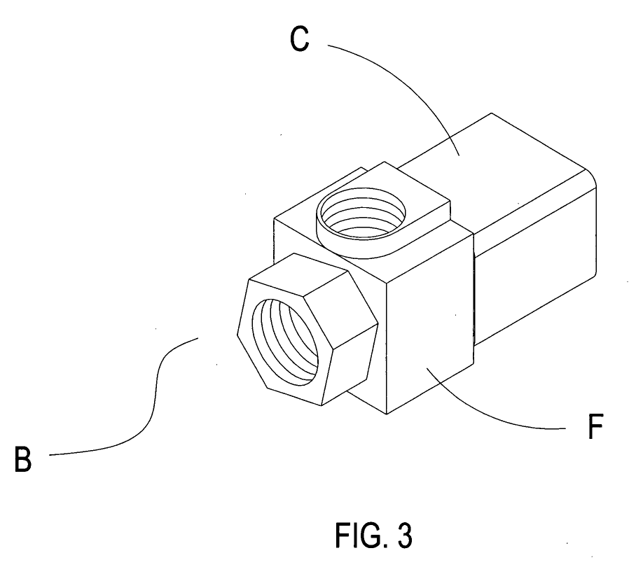

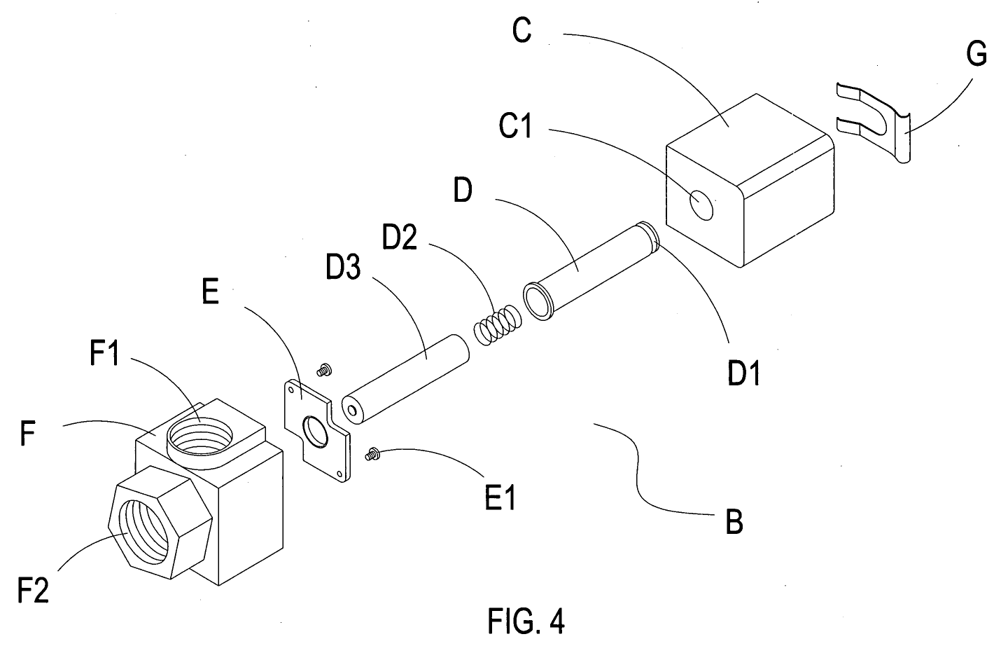

Referring to FIGS. 3 to 5, the present invention is to provide an electric automatic discharge valve B, which is constituted by a solenoid valve C, a cylindrical tube D, a fixing piece E, a guiding gate F, and a latching piece G. The solenoid valve C is provided with a through-hole C1 which is transfixed into the cylindrical tube D, and a slide D1 at an end of the cylindrical tube D is penetrated from the through-hole C1 of the solenoid valve C to be assembled and fixed with the latching piece G; whereas the other end of the cylindrical tube D is assembled at a guiding hole F5 of the guiding gate F, and is screwed by the fixing piece E in association with a screw E1. Furthermore, an interior of the cylindrical tube D is provided with an elastic element D2 and a moveable plug D3 to control liquid flowing between an inlet hole F1 and an outlet hole F2 of the guiding gate F.

The inlet hole F1 of the guiding gate F is perpendicular to the outlet hole F2 and has level difference that is higher than a flow hole F4, such that when the liquid flows through the inlet hole F1 and the outlet hole F2, a vortex can be created by the flow hole F4. On the other hand, a slope F3 is located at a place of the inlet hole F1 of the guiding gate F, opposed to the outlet hole F2, to intensify the vortex, accelerate discharge speed of the liquid, and effectively remove impurities in the liquid.

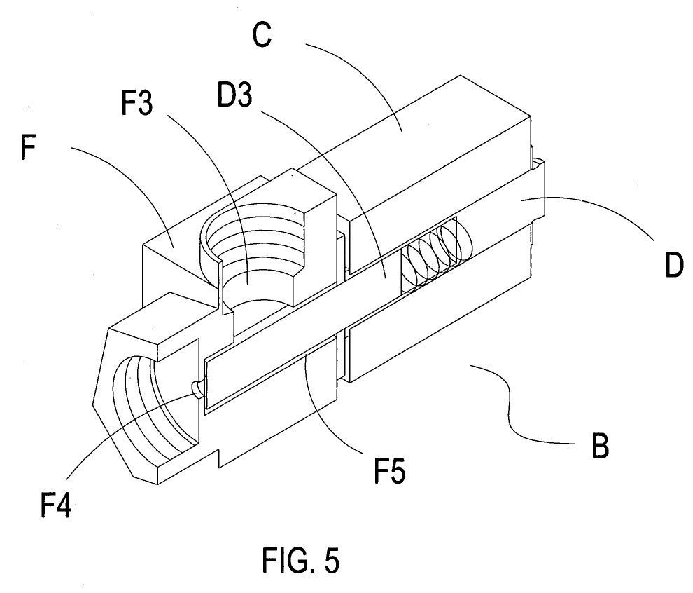

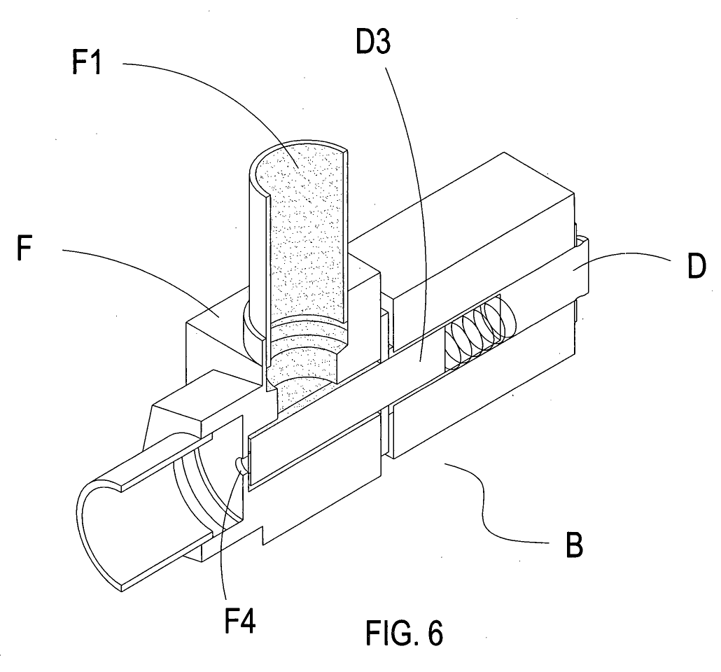

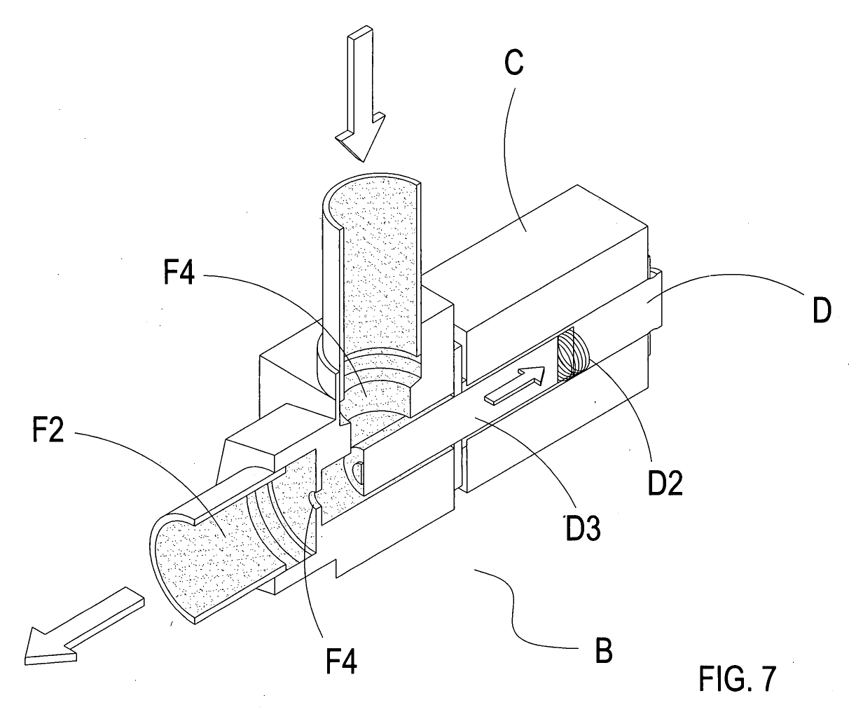

Referring to FIGS. 5 to 7, when the liquid flows into the guiding gate F from the inlet hole F1, the flow hole F4 of the guiding gate F will be in a closure state by the moveable plug D3 which is extended from the cylindrical tube D transfixed in the guiding gate F, prohibiting the liquid from passing through the flow hole F4. After the solenoid valve C is excited to generate magnetic force, the moveable plug D3 extended from the cylindrical tube D will be sucked away from the flow hole F4 by the magnetic force, enabling the liquid in the guiding gate F to pass through the flow hole F4 successfully. On the other hand, when magnetism of the solenoid valve C disappears, the moveable plug D3 in the cylindrical tube D will be pushed back to the flow hole F4 by elastic force of the elastic element D2, such that the flow hole F4 of the outlet hole F2 can be formed with a closure state, thereby achieving an effect of controlling the discharge of liquid. In addition, by the facts that the level difference of the inlet hole F1 is higher than the flow hole F4, and the interior of the guiding gate F is provided with the slope F3, the discharge valve B can effectively achieve the functions of discharging the liquid and removing the impurities.

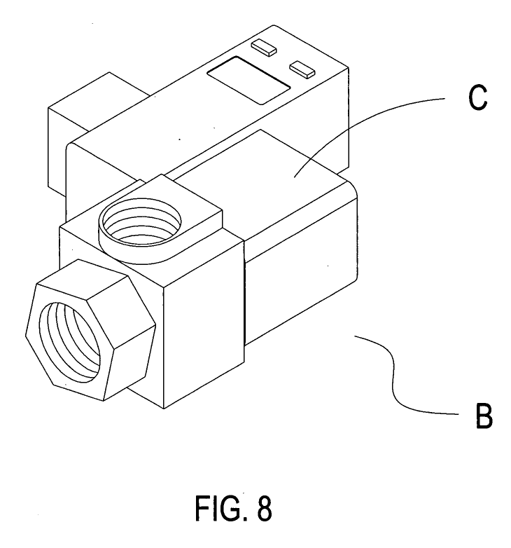

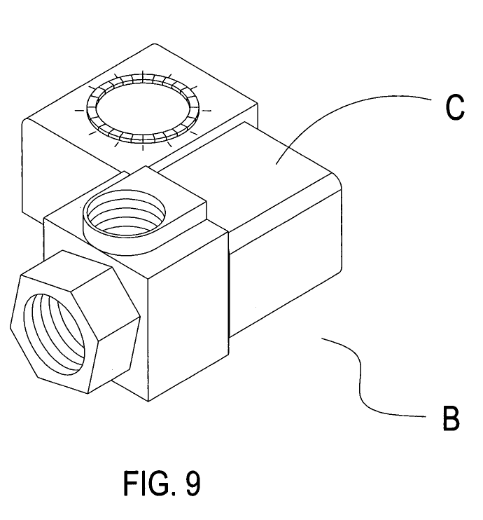

Referring to FIG. 8 and FIG. 9, the solenoid valve C can be further added with an automatic control device which can be configured with a time of activating to automatically magnetize the solenoid valve C upon reaching the configured time, such that the discharge valve B can achieve a function of automatic depressurization, wherein the automatic control device can be further provided with an electric or mechanical device which can be set up to discharge the liquid automatically.

To further manifest the advancement and practicability of the present invention, the present invention is compared with a prior art as follow.

Shortcomings of a Prior Art
1. The inlet tube and the outlet tube are connected horizontally, causing the low flow speed of the liquid.
2. According to item 1, the liquid cannot be discharged effectively.
3. The impurities of the liquid are easily retained in the outlet tube, guiding gate, and inlet tube, thereby easily causing accumulation of the impurities.

4. According to item 3, the impurities are accumulated easily.

Advantages of the Present Invention
1. The level difference of the inlet hole is higher than the flow hole, so as to increase the flow speed of the liquid and create the effect of vortex.
2. According to item 1, the liquid can be discharged effectively.
3. The impurities of the liquid can be successfully discharged from the guiding gate, so as to prevent the impurities from being accumulated.
4. It is provided with the advancement and practicability.
5. It can improve industrial competitiveness.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An electric automatic discharge valve comprising a solenoid valve, a cylindrical tube, a fixing piece, a guiding gate, and a latching piece, wherein the solenoid valve is transfixed with the cylindrical tube, and end of which is connected with the latching piece, the other end of which is extended with a moveable plug being transfixed into the guiding gate, and which is fixed at the guiding gate by the fixing piece in association with a screw; the guiding gate including an inlet hole, a flow hole, and an outlet hole, with level difference of the inlet hole being higher than the flow hole, such that when liquid flows through the inlet hole and the outlet hole, a vortex is created by the flow hole; an interior of the guiding gate being provided with a slope for intensifying the vortex, such that the liquid is accelerated upon discharging, and impurities of the liquid are removed effectively.

2. The electric automatic discharge valve according to claim 1, wherein the discharge valve is further applied to a water bucket, an oil bucket, or other related device which is loaded with the liquid.

3. The electric automatic discharge valve according to claim 1, wherein the solenoid valve is further provided with a conduction terminal, such that the solenoid valve is extended and connected with a related device which discharges the liquid automatically.

4. The electric automatic discharge valve according to claim 2, wherein the solenoid valve is further extendedly provided with an electric or a mechanical device which is set up to discharge the liquid automatically.
